(19) United States
(12) Patent Application Publication
(10) Pub. No.: US 2021/0027343 A1
(43) Pub. Date: Jan. 28, 2021

(54) System for Vehicle Identification Utilizing Infrared Signals

(71) Applicant: Juan Manuel Miranda, Toronto (CA)

(72) Inventor: Juan Manuel Miranda, Toronto (CA)

(21) Appl. No.: 17/071,147

(22) Filed: Oct. 15, 2020

(51) Int. Cl. G06Q 30/02; G06Q 30/00; G08G 1/017; G07B 15/02; G08G 1/04; G06K 15/02; G06K 7/12

(52) U.S. Cl. CPC G06Q 30/0284; G06Q 30/0185; G08G 1/017; G06K 7/12; G08G 1/04; G06Q 2240/00; G06K 15/02; G07B 15/02

(57) ABSTRACT

The system includes a set of infrared transmitters that are installed in a vehicle. These transmitters are configured to send out coded infrared signals that provide detailed information unique to the vehicle. The infrared binary signals beamed by the transmitters will reach a control panel installed at the entrance of a parking lot or gated facility where there is a requirement that arriving vehicles be identified and/or registered. The control panel is provided with an infrared sensor that is capable of receiving and processing the coded signals beamed by the vehicle transmitter. The infrared sensor is operatively connected to a control circuit that is configured to decode the signals received and to send the data to a computer. The information thus received is logged and registered in the computer for billing or for any other tasks that might be required.

### FIELD OF THE INVENTION

The present invention relates generally to any facility or compound where the identification, control and management of vehicles is required before access is granted.

### BACKGROUND OF THE INVENTION

The entrance to any facility that does not permit free access to vehicles is normally guarded by fence gates or by barriers. Before a vehicle is authorized to enter, either the vehicle driver will be personally identified by an attendant or will need to get registered by obtaining a ticket or using a credit card or similar (in the case of paying parking lots).

In some instances employees are responsible for the identification of vehicles and for the operation of gates that guard the entrance to the site. In some other cases, diverse elements such as tickets, magnetic cards, credit cards, fob keys, or manually entered codes are utilized to activate the devices controlling the access to private facilities.

Referring now to paying parking lots, when a vehicle is ready to exit the premises, the issued ticket or the credit card utilized at the entrance must be verified, or read, by a person or a machine, to calculate the parking fee owed by the driver.

The steps described above are obviously time-consuming. They introduce a delay factor into the flow of traffic seeking to go through. The present invention will help users overcome these limitations by providing a fast, accurate and efficient method for identification, control and registration of vehicles that arrive at a private facility.

### PRIOR ART

The U.S. Pat. No. 4,121,102 registered on Oct. 17, 1978 by S. Wilson bears some similarities to the present invention however, there are important differences:
The Wilson patent utilizes transponders to provide the communication link required by this design. The proposed invention does not use transponders, resulting in a simpler and less expensive installation.
The operation of transponders requires a signal emitter or “interrogator”. This element is not used in the proposed invention.
The Wilson patent discloses a signal encoding process that is different to the PCM (pulse code modulation) technology used in the proposed invention. A greater amount of data could be transmitted by the proposed design because of this significant difference.

### SUMMARY OF THE INVENTION

In accordance with one aspect of the present invention, a control panel is installed near a gated access to a private facility or parking lot. The control panel includes one or more infrared sensors directionally oriented to face vehicles attempting to enter the private facility. The infrared sensor is coupled to a control circuit that is configured to decode binary signals beamed by infrared transmitters installed in the vehicles. The binary signals are coded using pulse control modulation (PCM) technology. In this way, vehicle information that may include various details such as the license plate number, the authority issuing the plate, the make and model of the vehicle, will be provided via the coded binary signals. This data will be interpreted by the control circuit and it will be sent to a computer for logging, control and registration. A computer program is utilized to verify if the license plate number is included in a list of approved users, and the program will make a decision if the vehicle is authorized to enter the facility.

The present invention can also be used for the commercial operation of a paying parking lot. A computer connected to a plurality of control panels installed in the premises will be able to track the time a vehicle has effectively remained at the facility and, in this way, accurately bill the appropriate parking fees. A simple calculation involving the arrival time and the exit time of the vehicle reported by the control panels installed at the access and exit gates will determine the parking fee.

With the foregoing in view, and other advantages as will become apparent to those skilled in the art to which this invention relates as this specification proceeds, the invention is further described by reference to the accompanying drawings forming a part hereof, which illustrate a certain embodiment of the principles of the present invention.

### BRIEF DESCRIPTION OF THE DRAWINGS

It should be understood that the different elements shown in the appended drawings illustrate typical embodiments of the invention and therefore should not be considered limiting of its scope:

FIG. 1 is a plan view of a typical access to a gated facility according to an exemplary embodiment of the invention.

FIG. 2 shows Section AA of the plan view included in FIG. 1.

FIG. 3 is a block diagram illustrating the key elements of the system according to an exemplary embodiment of the invention.

FIG. 4 is a flow chart illustrating the key steps of the system according to an exemplary embodiment of the invention.

### DETAILED DESCRIPTION OF THE INVENTION

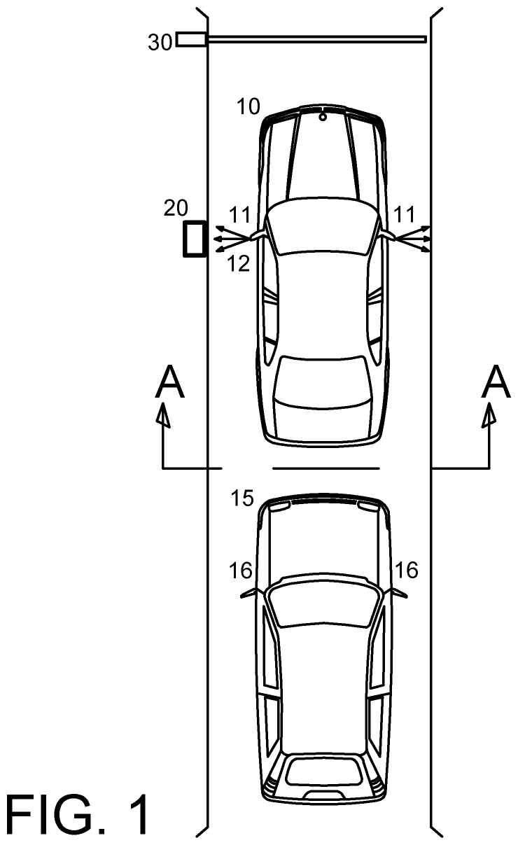

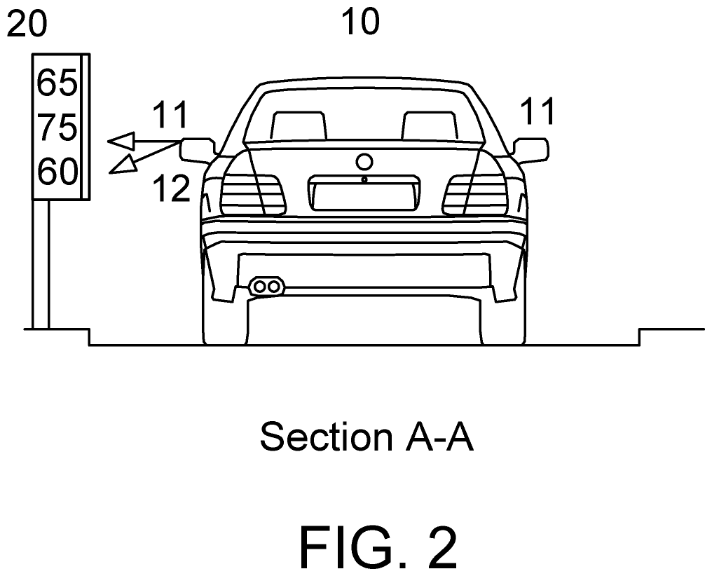

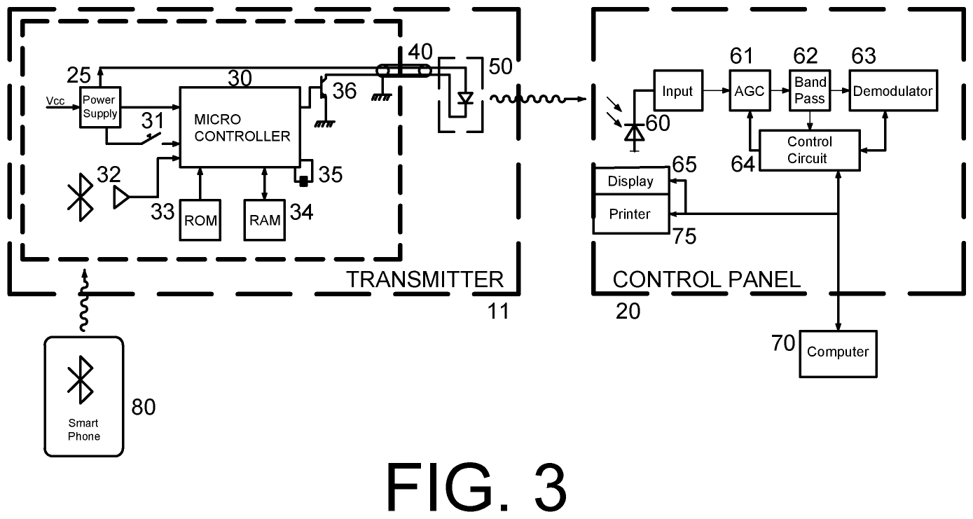

Referring firstly to FIG. 1, an embodiment of the invention is represented, two vehicles 10 and 15 are shown while waiting to enter the gated facility. The first car 10 is provided with infrared transmitters 11 installed in the vehicle mirrors. A control panel 20 is facing the driver side mirror of vehicle 10 and is in the line of sight of the infrared signals which are being beamed by the transmitter 11. In this way, the binary signals sent are detected and processed by the infrared sensor or receiver 60 shown in FIGS. 2 and 3.

It should be noted that the infrared signals that may be beamed by transmitters 16 installed in the mirrors of the second vehicle 15 will not reach the receiver 60 of the control panel 20 until vehicle 15 reaches a point that directly faces the control panel 20. In this way vehicle 15 will not interfere with the process under way regarding vehicle 10.

When the coded binary signals sent by the transmitter 11 are properly received, decoded and processed, the computer 70 in FIG. 3 that is operatively coupled to the control panel 20 will send out the order to open the gate 30 and allow vehicle 10 to proceed. A visual confirmation of this activity will be also provided in the control panel display 65 in FIG. 3. The command to open the gate 30 will not be issued until the vehicle's unique identification information beamed by the transmitter 11 has been verified by the software, and the verification requirements set by the installed program have been met.

Under another embodiment of the invention, the control panel 20 will be provided with a printer 75 shown in FIG. 3, which will print a receipt once the registration of the vehicle has been completed, and the driver of the vehicle will pick up the ticket as required.

Referring now to FIG. 2, vehicle 10 is shown sending infrared binary signals to the control panel 20. The receiver 60 will be able to detect, decode and register the unique vehicle information that has been beamed by the transmitter 11. Once the signals have been processed, the display 65 in the control panel 20 will provide a visual and/or audio indication to the vehicle driver to confirm that the operation has been completed. If the signals are not readable, the display 65 will warn the vehicle driver that the infrared signals will need to be sent again.

Under another embodiment of the invention, once the vehicle signals have been read and processed, the control panel 20 will send out an infrared signal which may be detected by an infrared receiver installed in the vehicle mirror 12. This incoming signal may be processed by the microcontroller and sent for storage purposes to the RAM memory 34, as shown in FIG. 3. Also, the signal may be sent to the vehicle driver's cell phone 80 via a Bluetooth link 32, as shown in FIG. 3. An app will be developed for such service.

FIG. 3 is a block diagram illustrating the key elements of the system according to an exemplary embodiment of the invention. The transmitter 11 is provided with a power supply circuit 25 that would normally be connected to the vehicle battery. A switch 31 is used to initiate the process of signal transmission. Switch 31 could be provided on the dashboard, or it could be integrated in the vehicle infotainment/control panel. The microcontroller 30 is connected to a crystal 35 used for signal generation. ROM (Read Only Memory) 33 is connected to the microcontroller 30 to provide vehicle information which will remain invariable as it cannot be reprogrammed in the field. Permanent data such as make and model of the vehicle would be stored in the ROM 33. Information that might change from time to time including the vehicle license plate number and the authority issuing that plate, will be programmed in the RAM (Random Access Memory) 34. This type of information could also be updated by accessing the microcontroller 30 via a Bluetooth application 32 and using a smart telephone 80. The microcontroller 30 is connected to a transistor 36 which will control the light emitting diode LED 50 used to transmit the infrared signals. A shielded cable 40 is required for the interconnection to prevent any external sources from interfering with the transistor 36 switching. The microcontroller 30 is configured to encode the signals using a pulse control modulation (PCM) or pulse width modulation (PWM) technology which allows the transmission of a large number of binary codes in milliseconds. In this way, the data stored in ROM and RAM will be transmitted by the emitting diode 50.

Continuing with the FIG. 3 diagram, binary signals detected by the infrared receiver 60 installed in the control panel 20 are sent to the automatic gain control 61 which is connected to the demodulator 63. The decoded information is sent to the control circuit 64 and then to the computer 70. The unique information pertaining to vehicle 10 will be logged, registered and verified by the computer program. In the case of private facilities, the software will determine whether the license plate of vehicle 10 is included in the list of authorized vehicles and the gate 30 will be opened when this step is verified.

In the case of paying parking lots, the computer will register the time and date of the arrival of the vehicle 10. This data will be used later to calculate the parking fee owed when vehicle 10 is ready to leave the premises and it has approached the control panel located at the facility exit gate.

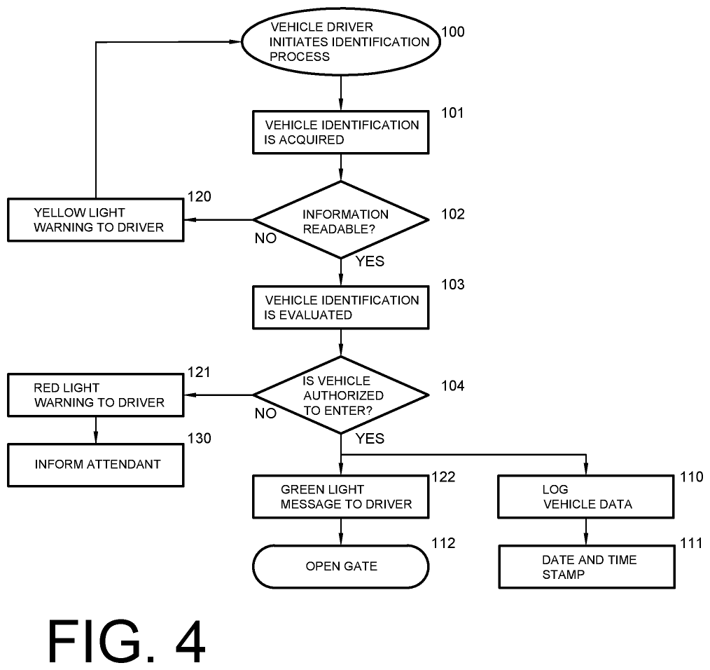

FIG. 4 is a logic flow chart showing the key steps of the system when a typical entrance to a private facility is considered. Step 100 shows that the operation is initiated by a vehicle that sends infrared coded signals to the control panel 20, as shown in FIG. 1. The information is acquired by the control panel 20 as indicated in step 101. If the data is not readable, step 102 shows that the yellow light will be energized in the display 65, shown in FIG. 2, and a message will be provided to the driver as per step 120. If the binary signals are read successfully, then the vehicle's unique information is evaluated per step 103. Typically the process will verify whether the license plate number (or any other data that may be used as a condition for granting access) is in a list that has been previously uploaded in the computer 70, shown in FIG. 3. If the vehicle is authorized to enter, step 104 will provide a command to display a green light and also a message (informing the driver of this decision) on the display 65, as illustrated in step 122. Once this is done, the gate will be opened as per step 112.

In addition, the relevant vehicle information will be logged in the computer 70 per step 110. The date and time of vehicle entry will also be recorded as shown in step 111.

If the vehicle is not authorized to enter, a command will be provided to display a red light and also a message (informing the driver of this decision) on the display 65 as shown in step 121. An attendant will be contacted to deal with the situation as indicated in step 130.

The invention claimed is:

1. A vehicle identification system that utilizes infrared coded signals, the system comprising:
a vehicle which is provided with at least one infrared transmitter (IRT), the IRT transmitter configured to store unique information related to the vehicle, the information may include the license plate number, the authority issuing the license plate, the vehicle make and model, the vehicle type, the IRT transmitter capable of sending out infrared signals that correspond to the vehicle identification data, the encoding method of the infrared signals utilizing a pulse control modulation (PCM) or pulse width modulation (PWM) technology;
a control panel (CP) which is located near the access area to a gated facility or private parking, the CP control panel is provided with at least one infrared sensor or receiver (IRR), the IRR receiver installed in such way as to detect the signals emitted by IRT transmitters of any plurality of vehicles attempting to enter the facility through the gate controlled by the CP control panel, the IRR receiver operatively connected to a control circuit (CC) that is capable of decoding and processing the binary signals detected by the IRR receiver;
a computer (PC) that is operatively connected to the CP control panel, the computer configured to receive and register the data decoded by the CP control panel, the PC computer capable of processing the said data to determine whether or not the vehicle is authorized to enter the facility, and/or record the time and date of the arrival of the authorized vehicles for ulterior billing purposes or other management applications.

2. The vehicle identification system of claim 1, wherein the CP control panel is located near the exit gates of a private facility and the PC computer determines the parking fee owed by the driver for the amount of time that the particular vehicle has remained in the facility.

3. The vehicle identification system of claim 1, wherein a printer is provided in the CP control panel for issuing paper tickets to vehicle drivers when access to the site has been granted.

4. The vehicle identification system of claim 1, wherein the CP control panel and the vehicle further comprise:
an infrared transmitter (CPT) that is provided in the CP control panel for sending information to the vehicle, whereby the information beamed by the CPT transmitter may include the facility location, telephone and name, the time and date of the transaction,
an infrared receiver (VIR) is installed in the vehicle, whereby the signals sent by the CPT transmitter are detected and processed by VIR receiver, the data is stored in the Random Access Memory (RAM) of the vehicle, and optionally the data may also be sent to a smart phone which is paired to the vehicle via a Bluetooth link.

5. The vehicle identification system of claim 1, wherein a hand held infrared transmitter (HHT) is used by the vehicle driver to send binary codes with unique vehicle information when the HHT transmitter is pointed by the driver towards the CP control panel, as the vehicle arrives at the gate, which enables the detection of said signals by the IRR receiver installed in the control panel.
